(19) United States
(12) Patent Application Publication
(10) Pub. No.: US 2026/0326522 A1
(43) Pub. Date: Oct. 22, 2026

(54) GLASS RUN

(71) Applicant: TOYODA GOSEI CO., LTD., Kiyosu-shi (JP)

(72) Inventors: Yuto UEHARA, Kiyosu-shi (JP); Masatoshi NOJIRI, Kiyosu-shi (JP)

(21) Appl. No.: 19/640,521

(22) Filed: Apr. 7, 2026

(30) Foreign Application Priority Data
Apr. 22, 2025 (JP) 2025-070339

(51) Int. Cl. B60J 10/76

(52) U.S. Cl. CPC B60J 10/76

(57) ABSTRACT

A glass run having a bottom wall, a vehicle outer side wall, and a vehicle inner side wall as a basic structure, the basic structure being attached to a door frame and guiding raising and lowering of a door glass, the glass run including a hard portion that contacts the door glass and has a hardness higher than that of a base material portion constituting the basic structure, and a vibration damping portion that is positioned on a side of the hard portion opposite to the door glass and has high vibration damping performance.

### CROSS REFERENCE TO RELATED APPLICATION

This application claims the priority benefit of Japanese Patent Application No.2025-070339 filed on Apr. 22, 2025. The entirely of the above-mentioned patent application is hereby incorporated by reference herein and made a part of this application.

### BACKGROUND OF THE INVENTION

### 1. Field of the Invention

The present invention relates to a glass run attached to a door of a vehicle such as an automobile.

### 2. Description of Related Art

Improving quietness of vehicles such as automobiles enhances the comfort of occupants and therefore serves as a strong appeal point for improving product value. Further, in electric vehicles, which are becoming increasingly widespread, the conventional engine is no longer installed, and with the elimination of engine noise, the primary remaining noises that become noticeable are road noise and wind noise. Therefore, there is an increasing need for these reduction techniques.

For example, there is known a technique of reducing vibration by using impedance matching that brings the impedance of a glass run close to the impedance of glass by increasing the rigidity of the glass run (for example, Japanese Patent Application Laid-Open No. 2023-53894).

FIG. 5 illustrates a technique disclosed in Japanese Patent Application Laid-Open No. 2023-53894. A glass run 100 includes a bottom wall 200, a vehicle outer side wall 300, and a vehicle inner side wall 400 as its basic structure. The basic structure is attached to a door frame groove portion 500 formed in a door frame 310 and guides the raising and lowering of a door glass 600. On the vehicle inner side of the vehicle outer side wall 300, a thick portion 330 (hard portion) having a hardness higher than that of the vehicle outer side wall base material portion 320 of the vehicle outer side wall 300 is formed so as to protrude toward the vehicle inner side and come into sliding contact with the door glass 600.

When the thick portion 330 having high hardness comes into contact with the door glass 600, vibration can be reduced by efficiently transmitting the vibration of the door glass 600 to the glass run 100 through impedance matching.

### SUMMARY OF THE INVENTION

By the way, with regard to efforts to further improve quietness of vehicles such as automobiles, further improvements are also required for glass runs. Therefore, the present invention provides a glass run capable of further reducing vibration.

In order to solve the above problems, a first aspect of the present invention is a glass run having a bottom wall, a vehicle outer side wall, and a vehicle inner side wall as a basic structure, the basic structure being attached to a door frame and guiding raising and lowering of a door glass, the glass run including a hard portion that contacts the door glass and has a hardness higher than that of a base material portion constituting the basic structure, and a vibration damping portion that is positioned on a side of the hard portion opposite to the door glass and has high vibration damping performance.

In the first aspect of the present invention, since the glass run includes a hard portion that contacts the door glass and has a hardness higher than that of the base material portion constituting the basic structure, and a vibration damping portion that is positioned on a side of the hard portion opposite to the door glass and has high vibration damping performance, vibration energy of the door glass can be efficiently transmitted to the hard portion by impedance matching, and the vibration energy transmitted to the hard portion can be reduced by the vibration damping portion having high vibration damping performance. As a result, vibration of the door glass can be further reduced, and thus in-vehicle noise can be further reduced.

A second aspect of the present invention is the glass run according to the first aspect, in which a material constituting the vibration damping portion has a loss factor (tan δ) of 0.3 to 2.0 at 20° C in a frequency range of 0.4 to 10 kHz and/or a Young’s modulus of 1 MPa to 12 MPa at 20° C.

In the second aspect of the present invention, since the material constituting the vibration damping portion has a loss factor (tan δ) of 0.3 to 2.0 at 20° C in a frequency range of 0.4 to 10 kHz and/or a Young’s modulus of 1 MPa to 12 MPa at 20° C, vibration energy can be efficiently converted into thermal energy by internal loss (hysteresis) derived from friction and entanglement of molecular chains inside the material. As a result, vibration of the door glass can be further reduced, and thus in-vehicle noise can be further reduced.

In a case where the loss factor (tan δ) is less than 0.3, the ability to convert vibration energy into heat (vibration absorption performance) is low, and vibration is transmitted as it is. Further, in a case where the loss factor (tan δ) exceeds 2.0, viscosity is too high, and energy is used for self-deformation rather than for vibration damping effects.

In a case where the Young’s modulus is less than 1 MPa, the ability to convert vibration energy into heat (vibration absorption performance) is low, and vibration is transmitted as it is. Further, when the Young’s modulus exceeds 12 MPa, vibration is not damped due to excessive hardness. Note that, regarding the Young’s modulus, a range of 1 MPa to 6 MPa is more effective.

A third aspect of the present invention is, in the first aspect or the second aspect, a glass run in which the hard portion and the vibration damping portion are formed on the vehicle outer side wall.

In a glass run, the vehicle outer side wall and the vehicle inner side wall are attached in contact with a door frame. Further, since the door glass moves so as to be positioned on the vehicle outer side immediately before being raised and closed, a pressing direction of the door glass is toward the vehicle outer side wall, and the vehicle outer side wall is sandwiched between the door frame and the door glass and is pressed by the door glass. Accordingly, rigidity, that is, an increase in reaction force from the glass run with respect to a displacement amount of a pressed portion when the glass run is pressed by the door glass, is greater on the vehicle outer side wall. Further, there are many glass runs in which the door glass contacts the vehicle outer side wall.

In the third aspect of the present invention, since the hard portion and the vibration damping portion are formed on the vehicle outer side wall, vibration energy of the door glass can be transmitted to the hard portion formed on the vehicle outer side wall by impedance matching by forming the hard portion on the vehicle outer side wall having high rigidity due to being sandwiched between the door frame and the door glass and pressed by the door glass, and the transmitted vibration energy can be reduced by the vibration damping portion. As a result, vibration of the door glass can be further reduced, and thus in-vehicle noise can be further reduced.

A fourth aspect of the present invention is the glass run according to the third aspect in which a thickness of the vibration damping portion is 30% or more of a thickness of the vehicle outer side wall excluding the hard portion.

In the fourth aspect of the present invention, since the thickness of the vibration damping portion is 30% or more of the thickness of the vehicle outer side wall excluding the hard portion, a sufficient region for converting vibration energy into thermal energy can be secured in a thickness direction of the vehicle outer side wall. As a result, vibration of the door glass can be further reduced, and thus in-vehicle noise can be further reduced.

Note that the effect is higher when the thickness of the vibration damping portion is 50% or more of the thickness of the vehicle outer side wall excluding the hard portion, and is even better when it is 65% or more.

In a case where the thickness of the vibration damping portion is less than 30% of the thickness of the vehicle outer side wall excluding the hard portion, a region for converting vibration energy into thermal energy in the thickness direction of the vehicle outer side wall is small, and conversion into thermal energy becomes insufficient.

Note that, since the thickness of the vibration damping portion is 30% or more of the thickness of the vehicle outer side wall excluding the hard portion, the vehicle outer side wall excluding the hard portion may entirely be the vibration damping portion, that is, 100%.

A fifth aspect of the present invention is the glass run according to the third aspect or the fourth aspect in which the vibration damping portion is formed to have a length of 0.5 times to 1.5 times a length of the hard portion in a longitudinal direction of the vehicle outer side wall.

Here, the “longitudinal direction of the vehicle outer side wall” refers to a direction connecting a portion connected to the bottom wall and a tip end portion of the vehicle outer side wall.

In the fifth aspect of the present invention, since the vibration damping portion is formed to have a length of 0.5 times to 1.5 times the length of the hard portion in the longitudinal direction of the vehicle outer side wall, vibration energy of the door glass transmitted by the hard portion can be transmitted to the vibration damping portion in the longitudinal direction, and the vibration energy can be reduced by the vibration damping portion having high vibration damping performance. As a result, vibration of the door glass can be further reduced, and thus in-vehicle noise can be further reduced.

In a case where the vibration damping portion has a length of less than 0.5 times the length of the hard portion in the longitudinal direction of the vehicle outer side wall, vibration energy of the door glass transmitted by the hard portion cannot be sufficiently transmitted to the vibration damping portion in the longitudinal direction. Further, in a case where the length exceeds 1.5 times the length of the hard portion, rigidity of the vehicle outer side wall decreases, and thus the vehicle outer side wall is likely to be deformed when mounted to the door frame or when contacting the door glass.

A sixth aspect of the present invention is the glass run according to the third aspect in which the hard portion is provided on a vehicle outer side of the vibration damping portion.

In the sixth aspect of the present invention, since the hard portion is provided on the vehicle outer side of the vibration damping portion, rigidity of the vehicle outer side wall is increased, and vibration that has passed through the vibration damping portion can be dissipated to the door frame. As a result, vibration of the door glass can be further reduced, and thus in-vehicle noise can be further reduced.

A seventh aspect of the present invention is the glass run according to the first aspect to the sixth aspect in which the vibration damping portion is a dynamically crosslinked thermoplastic elastomer (TPV) or a styrene-based thermoplastic elastomer (TPS).

In the seventh aspect of the present invention, since the vibration damping portion is a dynamically crosslinked thermoplastic elastomer (TPV) or a styrene-based thermoplastic elastomer (TPS), a desired loss factor (tan δ) and Young’s modulus can be easily obtained.

### BRIEF DESCRIPTION OF THE DRAWINGS

FIG. 1 is a front view of an automobile door;

FIG. 2 is a front view illustrating a glass run used for a door frame of FIG. 1;

FIG. 3 is a cross-sectional view taken along line A-A of FIG. 1 according to a first embodiment of the present invention;

FIG. 4 is a cross-sectional view taken along line A-A of FIG. 1 according to a second embodiment of the present invention; and

FIG. 5 is a cross-sectional view illustrating an attachment structure of a conventional glass run (Japanese Patent Application Laid-Open No. 2023-53894).

### DETAILED DESCRIPTION OF PREFERRED EMBODIMENTS

A first embodiment of the present invention will be described with reference to FIGS. 1-3. FIG. 1 is a front view of a left front door 1 of an automobile as viewed from a vehicle outer side. A door frame 3 is mounted on an upper portion of a door main body 2 that constitutes the front door 1. A window opening is formed by the door frame 3 and an upper edge of the door main body 2. A glass run 10 is attached to a door frame groove portion 5 formed in the door frame 3 and to an inside of the door main body 2 to guide the vertical movement of a door glass 4. It should be noted that the present invention is applicable not only to the left front door 1, but also to a right front door and right and left rear doors. Further, it can also be applied to a sliding door in which the door glass moves up and down.

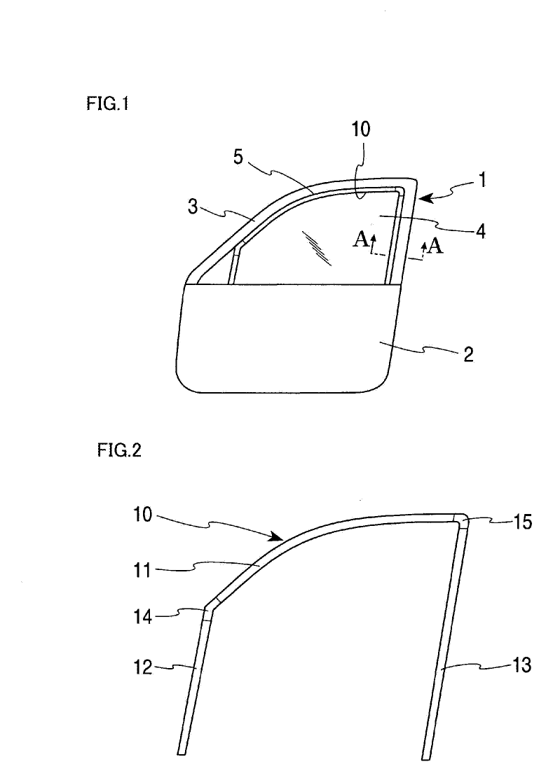

FIG. 2 is a simplified front view of only the glass run 10 as viewed from the vehicle outer side. The glass run 10 is composed of a first extrusion portion 11 corresponding to a horizontal frame portion of the door frame 3, a second extrusion portion 12 corresponding to a front vertical frame portion of the front door 1, and a third extrusion portion 13 corresponding to a rear vertical frame portion. The front end portion of the first extrusion portion 11 is connected to an upper end portion of the second extrusion portion 12 by a first molded portion 14. Further, the rear end portion of the first extrusion portion 11 is connected to an upper end portion of the third extrusion portion 13 by a second molded portion 15. FIGS. 1 and 2 are also used for a second embodiment described later.

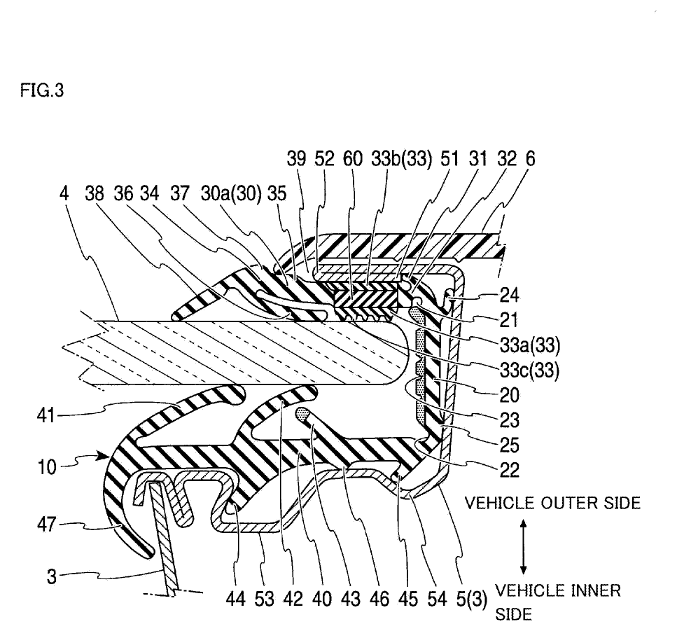

FIG. 3 is a cross-sectional view taken along line A–A of FIG. 1, and is a cross-sectional view illustrating a state in which a glass run 10 is attached to a door frame groove portion 5 of a door frame 3 and the glass run 10 is in contact (sliding contact) with a door glass 4. The glass run 10 includes a basic structure including a bottom wall 20, a vehicle outer side wall 30, and a vehicle inner side wall 40. Further, the vehicle inner side wall 40 is formed larger than the vehicle outer side wall 30, and its shape is asymmetrical with the vehicle inner side being larger.

At a connecting portion between the bottom wall 20 and the vehicle outer side wall 30, a vehicle outer groove portion 21 is formed, and at a connecting portion between the bottom wall 20 and the vehicle inner side wall 40, a vehicle inner groove portion 22 is formed. Here, the vehicle inner groove portion 22 is formed thicker than the vehicle outer groove portion 21. Further, in order to make the vehicle inner groove portion 22 thicker, a projecting portion 25 protruding from the bottom wall 20 is formed on a side opposite to the vehicle inner groove portion 22. The projecting portion 25 may be omitted as long as the thickness of the vehicle inner groove portion 22 is ensured.

The bottom wall 20 is formed in a substantially plate shape, and on an inner surface (the door glass 4 side) of the bottom wall 20, a plurality of concave portions 23 of the bottom wall are continuously and parallelly formed in a longitudinal direction (a direction from a front side to a back side of the drawing). Further, on an outer surface of the bottom wall 20, a bottom wall seal lip 24 is formed.

On the vehicle outer side of the vehicle outer side wall 30, a vehicle outer holding lip 31 extending toward the vehicle outer side wall 30 in the tip end portion direction is formed in the vicinity of the connecting portion with the bottom wall 20. Further, at a base portion of the vehicle outer holding lip 31 of the vehicle outer side wall 30, a thin-walled portion 32 having a reduced thickness is formed.

On a vehicle inner side of the vehicle outer side wall 30, a hard portion 33 having a hardness higher than that of a material of a base material portion 30a constituting the vehicle outer side wall 30 is formed. The hard portion 33 is divided into a vehicle inner hard portion 33a formed on the vehicle inner side of the vehicle outer side wall 30, and a vehicle outer hard portion 33b formed on the vehicle outer side and is formed.

The vehicle inner hard portion 33a projects from the vehicle outer side wall 30 toward the vehicle inner side and is formed. On the other hand, the vehicle outer hard portion 33b is located inside the vehicle outer side wall 30 and is formed to be exposed on the vehicle outer side of the vehicle outer side wall 30. Further, the vehicle outer hard portion 33b is formed at a position substantially facing the vehicle inner hard portion 33a.

On the vehicle inner surface of the vehicle inner hard portion 33a, a plurality of convex ribs 33c are continuously and parallelly formed in the longitudinal direction (a direction from the front side to the back side of the drawing). By forming the ribs 33c, dust, dirt, or foreign matter is prevented from being caught in the vehicle inner hard portion 33a during raising and lowering of the door glass 4, and generation of abnormal noise associated therewith can be prevented.

The vehicle outer hard portion 33b is not formed in the thin-walled portion 32. The vehicle outer hard portion 33b is formed in a direction toward a tip end portion 34 of the vehicle outer side wall 30 (a longitudinal direction of the vehicle outer side wall 30) from the thin-walled portion 32.

In a region between the vehicle inner hard portion 33a and the vehicle outer hard portion 33b, a vibration damping portion 60 is formed in contact with the vehicle inner hard portion 33a and the vehicle outer hard portion 33b. A thickness of the vibration damping portion 60 is about 70% of a thickness of the vehicle outer side wall 30 excluding the vehicle inner hard portion 33a (hard portion 33). Further, in the longitudinal direction of the vehicle outer side wall 30, the vibration damping portion 60 has a length of 1.0 times a length of the vehicle inner hard portion 33a (hard portion 33), that is, is formed in a region on the vehicle outer side of the vehicle inner hard portion 33a (hard portion 33).

In the vehicle outer side wall 30, a stepped portion 35 having an increased wall thickness is formed in a direction toward the tip end portion 34 from the vehicle outer hard portion 33b.

The vehicle outer seal lip 36 is formed from the tip end portion 34 of the vehicle outer side wall 30 in the direction toward the vehicle inner side and the bottom wall 20 side. In the present embodiment, the vehicle outer seal lip 36 does not contact the vehicle inner hard portion 33a. Further, a holding rib 37 is formed on the vehicle outer side of the tip end portion 34 of the vehicle outer side wall 30. Further, on the tip end side from the base portion of the vehicle outer seal lip 36 of the vehicle outer side wall 30, a vehicle outer cover lip 38 is formed in the direction toward the vehicle inner side and in the direction opposite to the bottom wall 20.

On the vehicle outer side of the vehicle inner side wall 40, a first vehicle inner seal lip 41 is formed to extend from the tip end portion of the vehicle inner side wall 40 toward the vehicle outer side and the bottom wall 20 side. Further, between the first vehicle inner seal lip 41 and the bottom wall 20, and extending toward the bottom wall 20 side, a second vehicle inner seal lip 42 is formed. Further, on the vehicle outer surface of the vehicle inner side wall 40, on the bottom wall 20 side of the second vehicle inner seal lip 42, a sub-lip 43 is formed to extend toward the vehicle outer side and in the direction opposite to the bottom wall 20. The sub-lip 43 may be formed to extend toward the bottom wall 20 side. Furthermore, the sub-lip 43 may not be formed.

Further, on the vehicle inner side of the vehicle inner side wall 40, a second vehicle inner holding lip 45 is formed in the vicinity of the connecting portion with the bottom wall 20, extending toward the tip end portion of the vehicle inner side wall 40. A first vehicle inner holding lip 44 is formed to extend toward the tip end portion of the vehicle inner side wall 40 from between the second vehicle inner holding lip 45 and the tip end portion of the vehicle inner side wall 40. Further, between the first vehicle inner holding lip 44 and the second vehicle inner holding lip 45, a contact rib 46 is formed.

From the tip end portion of the vehicle inner side wall 40, a vehicle inner cover lip 47 is formed to extend toward the vehicle inner side and toward the bottom wall 20 side.

In FIG. 3, a center pillar 6 is attached on the vehicle outer side of the door frame groove portion 5. The door frame groove portion 5 is made of metal.

In the present embodiment, the glass run 10 was produced by extrusion molding using dynamically crosslinked thermoplastic elastomer (TPV).

With respect to Young’s modulus at 20° C, the vehicle inner hard portion 33a and the vehicle outer hard portion 33b have a Young’s modulus of 100 MPa to 300 MPa, the base material portion 30a constituting the vehicle outer side wall 30 has a Young’s modulus of 8 MPa to 12 MPa, and the vibration damping portion 60 has a Young’s modulus of 1 MPa to 6 MPa. Note that the Young’s modulus of the vibration damping portion 60 may be 8 MPa or more; however, in that case, a material having a Young’s modulus lower than that of the base material portion 30a is used.

Further, with respect to a loss factor (tan δ) at 20° C in a frequency range of 0.4 to 10 kHz, the vibration damping portion 60 has a loss factor of 0.3 to 2.0. Further, the loss factor of the hard portion 33 is smaller than that of the vibration damping portion 60, and the loss factor of the base material portion 30a is smaller than that of the hard portion 33.

In the first embodiment, the entire glass run 10 is formed of dynamically crosslinked thermoplastic elastomer (TPV); however, for example, the hard portion 33 may be formed of PP, the vibration damping portion 60 may be formed of a styrene-based thermoplastic elastomer (TPS), and the base material portion 30a may be formed of TPV, or different materials may be used.

When the glass run 10 is attached to the door frame groove portion 5 of the door frame 3, the bottom wall seal lip 24 of the bottom wall 20 elastically contacts the door frame groove portion 5, and the projecting portion 25 comes into contact with the door frame groove portion 5.

On the vehicle outer side of the vehicle outer side wall 30, the vehicle outer holding lip 31 comes into contact with a hemming-processed tip end portion 51 of the door frame groove portion 5 that has been subjected to hemming processing, and the vehicle outer hard portion 33b comes into surface contact with the vehicle inner side of the door frame groove portion 5 that has been subjected to hemming processing.

Further, the stepped portion 35 does not contact the bent portion of the hemming processing, that is, a vehicle outer tip end portion 52 of the door frame groove portion 5, and a tip end side gap portion 39 is formed between the stepped portion 35 and the vehicle outer tip end portion 52 of the door frame groove portion 5. Further, the tip end portion of the center pillar 6 comes into contact with the holding rib 37.

On the vehicle inner side of the vehicle inner side wall 40, the vehicle inner side wall 40 and the contact rib 46 come into contact with the door frame groove portion 5, and the first vehicle inner holding lip 44 and the second vehicle inner holding lip 45 come into contact with a first curved portion 53 and a second curved portion 54 of the door frame groove portion 5. Further, the vehicle inner cover lip 47 comes into contact with the door frame 3.

In FIG. 3, the vehicle outer groove portion 21 is deformed such that the vehicle inner side of the vehicle outer side wall 30 approaches the bottom wall 20 very closely, while in the vehicle inner groove portion 22, the vehicle outer side of the vehicle inner side wall 40 and the bottom wall 20 are deformed not to approach each other as closely toward the vehicle outer side, and is attached to the door frame groove portion 5.

When the door glass 4 is inserted between the vehicle outer side wall 30 and the vehicle inner side wall 40, on the vehicle outer side, the vehicle outer cover lip 38 deforms toward the side opposite to the bottom wall 20, and the vehicle outer seal lip 36 deforms toward the bottom wall 20 side and toward the vehicle outer side wall 30 side, and elastically contacts the vehicle outer side of the door glass 4.

Further, the vehicle outer side of the door glass 4 comes into contact with the rib 33c formed on the vehicle inner hard portion 33a of the hard portion 33.

On the other hand, on the vehicle inner side, the first vehicle inner seal lip 41 and the second vehicle inner seal lip 42 both deform toward the bottom wall 20 side and toward the vehicle inner side wall 40 side, and elastically contact the vehicle inner side of the door glass 4.

Evaluation of quietness was performed by attaching the glass run 10 to four sides of a square glass plate having sides of about 300 mm and a thickness of 4 mm, and measuring, with an acceleration sensor, vibration transmitted through the glass plate from a speaker installed in a reverberation chamber to a semi-anechoic chamber.

As a result, it was confirmed that, compared with the structure of FIG. 5 (background art), vibration characteristic levels were reduced in a frequency range of 3 kHz to 10 kHz, that is, noise was further reduced.

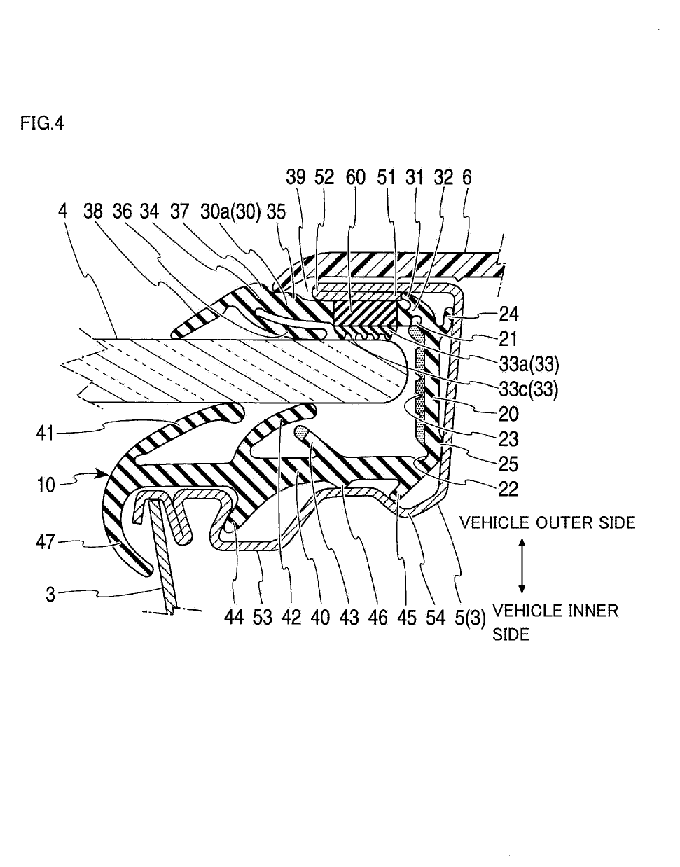

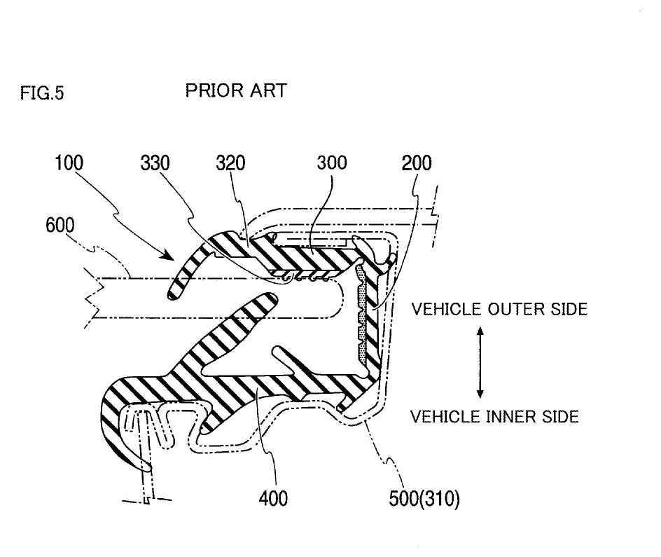

Next, a second embodiment of the present invention will be described with reference to FIG. 4. FIG. 4 is a cross-sectional view taken along line A–A of FIG. 1, illustrating a state in which the glass run 10 is attached to the door frame groove portion 5 of the door frame 3 and contacts (slidingly contacts) the door glass 4.

Differences of the second embodiment from the first embodiment described above are, with respect to the hard portion 33, firstly that the vehicle outer hard portion 33b is absent, and secondly that the vibration damping portion 60 is formed so as to penetrate the vehicle outer side wall 30 to the vehicle outer side. Accordingly, in the second difference, the thickness of the vibration damping portion 60 is 100% of the thickness of the vehicle outer side wall 30 excluding the hard portion 33.

Also in the second embodiment, the above-described quietness evaluation was performed, and similarly to the first embodiment described above, it was confirmed that, compared with the structure of FIG. 5 (background art), vibration characteristic levels were reduced in a frequency range of 3 kHz to 10 kHz, that is, noise was further reduced.

As described in detail above, according to the embodiments of the present invention, the following effects can be obtained.
(1) In the first embodiment and the second embodiment described above, since the hard portion 33 (vehicle inner hard portion 33a) having a hardness higher than that of the base material portion 30a and the vibration damping portion 60 having high vibration damping performance and positioned on a side of the hard portion 33 opposite to the door glass 4 are formed, vibration energy of the door glass 4 can be efficiently transmitted to the hard portion 33 (vehicle inner hard portion 33a) by impedance matching, and the vibration energy transmitted to the hard portion 33 (vehicle inner hard portion 33a) can be reduced by the vibration damping portion 60 having high vibration damping performance. As a result, vibration of the door glass 4 can be further reduced, and thus in-vehicle noise can be further reduced.
(2) Since a thickness of the vibration damping portion 60 is about 70% of a thickness of the vehicle outer side wall 30 excluding the vehicle inner hard portion 33a (hard portion 33) in the first embodiment, and is 100% in the second embodiment, a sufficient region for converting vibration energy into thermal energy can be secured in a thickness direction of the vehicle outer side wall 30. As a result, vibration of the door glass 4 can be further reduced, and thus in-vehicle noise can be further reduced.
(3) Since the vibration damping portion 60 is formed to have a length of 1.0 times a length of the hard portion 33 (vehicle inner hard portion 33a) in a longitudinal direction of the vehicle outer side wall 30 in both the first embodiment and the second embodiment, vibration energy of the door glass 4 transmitted by the hard portion 33 (vehicle inner hard portion 33a) can be transmitted to the vibration damping portion 60 in the longitudinal direction, and the vibration energy can be reduced by the vibration damping portion 60 having high vibration damping performance. As a result, vibration of the door glass 4 can be further reduced, and thus in-vehicle noise can be further reduced.
(4) In the first embodiment, since the hard portion 33 (vehicle outer hard portion 33b) is provided on a vehicle outer side of the vibration damping portion 60, rigidity of the vehicle outer side wall 30 is increased, and vibration that has passed through the vibration damping portion 60 can be dissipated to the door frame 3. As a result, vibration of the door glass 4 can be further reduced, and thus in-vehicle noise can be further reduced.

The embodiment of the present invention is not limited to the above embodiment, and various modifications can be made without departing from the object of the present invention.

In the first embodiment described above, the hard portion 33 (vehicle outer hard portion 33b) is formed on a vehicle outer side of the vibration damping portion 60; however, the vehicle outer hard portion 33b may not be formed, and a vehicle outer side of the vibration damping portion 60 may be the base material portion 30a.

In the first embodiment and the second embodiment described above, both the hard portion 33 and the vibration damping portion 60 are formed on the vehicle outer side wall 30; however, as long as the portions contact the door glass 4, for example, the hard portion 33 and the vibration damping portion 60 may be formed on a first vehicle inner side seal lip 41 or a second vehicle inner side seal lip 42 that contacts a vehicle inner side of the door glass 4.

In addition, in a first extrusion-molded portion 11 corresponding to a lateral frame portion of the door frame 3, the hard portion 33 and the vibration damping portion 60 may be formed on a vehicle outer side seal lip or a vehicle inner side seal lip. Further, when the door glass 4 contacts the bottom wall 20, for example, a seal lip protruding toward the door glass 4 may be formed on the bottom wall 20 to allow the seal lip to contact the door glass 4, and the hard portion 33 and the vibration damping portion 60 may be formed at a contact portion between the seal lip and the door glass 4.

In the above first embodiment and second embodiment, the door frame 3 having the door frame groove portion 5 has been described; however, the present invention can also be applied to the door frame 3 not provided with the door frame groove portion 5. In this case, for example, a vehicle outer cover lip extending toward the bottom wall 20 side may be formed on the vehicle outer side of the vehicle outer side wall 30, an outer frame may be inserted between the vehicle outer cover lip and the vehicle outer side wall 30 so that the outer frame comes into contact with the vehicle outer side wall 30 (or the vehicle outer hard portion 33b), and an inner frame may be inserted between the vehicle inner side wall 40 and the vehicle inner cover lip 47 so that the inner frame comes into contact with the vehicle inner side wall 40.

What is claimed is:

1. A glass run having a bottom wall, a vehicle outer side wall, and a vehicle inner side wall as a basic structure, the basic structure being attached to a door frame and guiding raising and lowering of a door glass, the glass run comprising:
a hard portion that contacts the door glass and has a hardness higher than that of a base material portion constituting the basic structure; and
a vibration damping portion that is positioned on a side of the hard portion opposite to the door glass and has high vibration damping performance.

2. The glass run according to claim 1, wherein a material constituting the vibration damping portion has a loss factor (tan δ) of 0.3 to 2.0 at 20° C in a frequency range of 0.4 to 10 kHz and/or a Young’s modulus of 1 MPa to 12 MPa at 20° C.

3. The glass run according to claim 1, wherein the hard portion and the vibration damping portion are formed on the vehicle outer side wall.

4. The glass run according to claim 3, wherein a thickness of the vibration damping portion is 30% or more of a thickness of the vehicle outer side wall excluding the hard portion.

5. The glass run according to claim 3, wherein the vibration damping portion is formed to have a length of 0.5 times to 1.5 times a length of the hard portion in a longitudinal direction of the vehicle outer side wall.

6. The glass run according to claim 3, wherein the hard portion is provided on a vehicle outer side of the vibration damping portion.

7. The glass run according to claim 1, wherein the vibration damping portion is a dynamically crosslinked thermoplastic elastomer (TPV) or a styrene-based thermoplastic elastomer (TPS).
